(19) United States
(12) Patent Application Publication
(10) Pub. No.: US 2009/0098025 A1
(43) Pub. Date: Apr. 16, 2009

(54) REACTION CONTAINER KIT

(76) Inventors: Nobuhiro Hanafusa, Kyoto (JP); Koretsugu Ogata, Kyoto (JP); Ryu Konoshita, Kyoto (JP); Akira Harada, Kyoto (JP); Masami Maekawa, Kyoto (JP)

Correspondence Address: Cheng Law Group, PLLC, 1100 17th Street, N.W., Suite 503, Washington, DC, 20036, US

(21) Appl. No.: 12/298,029

(22) PCT Filed: May 10, 2007
(86) PCT No.: PCT/JP2007/059687

§ 371 Date: Oct. 21, 2008

(30) Foreign Application Priority Data
May 11, 2006 (JP) 2006-132055

(51) Int. Cl. B01L 3/00

(52) U.S. Cl. 422/101; 422/102

(57) ABSTRACT

A reaction container kit in which a judgment can be made easily whether a sample is not yet injected or injected already while a sample is prevented from being injected into an incorrect reaction container erroneously. Before a sample is injected, the bar code (132) of a first bar code label is read out by means of a bar code reader and a judgment is made automatically whether that reaction container is a reaction container for the inspection items requested for the sample to be injected or not. If that reaction container is a correct one, the first bar code label (130) is peeled off and a sample is injected into a sample container (32). Subsequently, a second bar code label (134) is stuck onto the sample container (32). Consequently, an opening (31) is sealed hermetically with the second bar code label (134) and the sample is isolated from the outside under a state where the sample is introduced into the space of the reaction container covered with a cover (24).

### TECHNICAL FIELD

The present invention relates to a reaction container kit suitable for carrying out various analyses such as biological analyses, biochemical analyses, and general chemical analyses in the fields of medical care, chemistry, and the like.

### BACKGROUND ART

In biochemical analyses, general chemical analyses, and the like, micro multi-chamber devices are used as small-size reaction devices. As such a device, for example, a microwell reaction plate such as a microtiter plate, which has a flat plate substrate with a plurality of wells on the surface of the substrate, are used.

Further, a reaction container having a reaction portion for carrying out a reaction of a sample and a reagent container containing a reagent for use in the reaction of a sample has been proposed as a reagent kit.

In such a reaction container, a reagent which has been previously selected for an inspection item to be performed on a sample is contained in the reagent container.

### DISCLOSURE OF THE INVENTION

### Problems to be Resolved by the Invention

In a case where a sample is inspected using a reaction container having a reagent previously prepared, it is necessary to use a reaction container suitable for a requested inspection item. However, it is likely that the mistake of injecting a sample into an incorrect reaction container will be caused by human error.

Further, depending on the kind of reaction container, there is a case where it is difficult to determine whether a sample has already been injected or has not yet been injected thereinto.

It is therefore an object of the present invention to prevent a sample from being injected into an incorrect reaction container as well as to make it possible to easily determine whether a sample has already been injected or has not yet been injected.

### Means of Solving the Problems

A reaction container kit according to the present invention includes a reaction portion for carrying out a reaction of a sample, a reagent container containing a reagent for use in the reaction of a sample, a first bar code label to be read before sample dispensation into a reaction container, and a second bar code label to be read after sample dispensation into the reaction container. The first bar code label is previously stuck to the reaction container, and the second bar code label is provided so as to be able to be stuck to the reaction container. Data contained in the first bar code label and data contained in the second bar code label are different from each other, and the first bar code label contains at least data indicating information unique to the reaction container.

The first bar code label is read by a bar code reader before sample injection to automatically determine whether or not the reaction container is a correct one suitable for an inspection item requested to be performed on a sample to be injected thereinto.

The first bar code label may further contain data indicating that a sample has not yet been injected into the reaction container, and the second bar code label may contain data indicating that a sample has already been injected into the reaction container. When the reaction container has the first bar code label stuck thereto, it is possible, by reading the bar code label using a bar code reader, to confirm that a sample has not yet been injected into the reaction container. When the reaction container has the second bar code label stuck thereto, it is possible, by reading the bar code label using a bar code reader, to confirm that a sample has already been injected into the reaction container.

In order to prevent the first bar code label from being kept stuck to the reaction container even after sample injection, the first bar code label is preferably designed to be able to be entirely or partially removed from the reaction container after data reading.

In a case where the first bar code label is designed to be able to be partially removed, a portion of the first bar code label to be kept stuck to the reaction container without being removed therefrom may contain data indicating information unique to the reaction container, such as an inspection item to be performed using the reaction container, and a portion of the first bar code label that should be removed may contain data indicating that a sample has not yet been injected into the reaction container, and the second bar code label may contain data indicating that a sample has already been injected into the reaction container.

In a case where the first bar code label is designed to be able to be entirely or partially removed after data reading, it is preferred that the reaction container has an opening constituting a sample introduction unit and the first bar code label is previously stuck to the sample introduction unit so that the opening can be opened only after removing a portion of the first bar code label that should be removed. In this case, it is preferred that the second bar code label also serves as a sealing member for hermetically sealing the opening after sample injection.

In the case of a conventional microwell reaction plate, the top surface of the reaction plate is exposed to the atmosphere during use. Therefore, it is likely that a foreign matter will enter a sample from outside, and on the other hand, there is also a case where a reaction product will pollute an environment outside the reaction plate. For this reason, the reaction container kit according to the present invention is preferably designed to prevent the entry of a foreign matter from outside and the pollution of a surrounding environment.

One example of such a reaction container kit is one including a reaction plate having, on the top surface side thereof, a reaction portion and a reagent container, a dispensation tip arranged above the top surface of the reaction plate, and a cover for covering the space above the top surface of the reaction plate and movably supporting the dispensation tip so that a distal end portion of the dispensation tip is inside the space and a proximal end portion of the dispensation tip is outside the space. In this case, the opening described above is provided on the cover, and the sample introduction unit is designed so that a sample can be introduced into the space from outside through the opening.

The reagent container provided on the top surface side of the reaction plate is preferably sealed with a film. The film sealing the reagent container to prevent a reagent from spilling out of the reagent container is a film through which the dispensation tip can penetrate.

Further, since the space above the top surface of the reaction plate is covered with the cover so as to be cut off from the outside, the reaction of a sample is carried out in the space. The detection of a reaction product obtained by the reaction is also carried out in the space covered with the cover without taking the reaction product out of the space covered with the cover. After the detection, the reaction container is disposed of with the reaction product remaining in the space covered with the cover. That is, the reaction container is disposable.

The dispensation tip may be one to be attached to a tip of a dispensation nozzle. In this case, it is necessary to additionally prepare a nozzle mechanism in order to carry out dispensation. In order to eliminate the necessity to prepare a nozzle mechanism, the dispensation tip to be used in the present invention preferably has a syringe to be operated from the outside of the cover. In this case, operation of dispensation can be carried out by operating the syringe. Further, in a case where the dispensation tip has a syringe, the channel of the dispensation tip is sealed with the syringe, thereby preventing the space covered with the cover from communicating with the space outside the cover through the channel of the dispensation tip.

In a case where the dispensation tip does not have a syringe, the space covered with the cover is hermetically sealed with a nozzle mechanism during operation of dispensation, but is brought into communication with the space outside the cover through the dispensation tip when the dispensation tip is not used, such as during reaction or detection. In order to prevent the entry of a foreign matter from outside and the leakage of a sample or a reaction product into the outside even in such a case, the dispensation tip preferably has a filter inside the tip portion thereof.

In a case where the reaction container is intended for use in gene analysis, the reaction plate preferably has, on the top surface side thereof, a gene amplification portion for carrying out gene amplification reaction. The gene amplification portion preferably has a shape suitable for temperature control to be performed according to a predetermined temperature cycle. In this case, the reaction portion formed to have such a shape may be used as a gene amplification portion, or a gene amplification container may be provided separately from the reaction portion. Examples of the gene amplification reaction include PCR and LAMP.

The analysis of a reaction product may be carried out in the reaction portion of the reaction container. Alternatively, a reaction product may be transferred from the reaction portion to another site on the reaction plate in order to analyze the reaction product.

In a case where the reaction container is designed to carry out the analysis of a reaction product in the reaction portion, the reaction portion is preferably made of an optically-transparent material so that an optical measurement can be carried out from the bottom side of the reaction portion.

In a case where the reaction container is designed so that a reaction product can be transferred from the reaction portion to another site in order to analyze the reaction product, the reaction plate further has, on the top surface side thereof, an analysis section for analyzing a reaction product produced in the reaction portion.

One example of such an analysis section is an electrophoresis portion for carrying out electrophoretic separation of a reaction product.

In a case where a reaction product to be analyzed contains a gene, the analysis section is, for example, a region where probes which react with the gene are arranged. Examples of such a region where probes are arranged include DNA chips and hybridization regions.

One example of a structure for holding and movably supporting the dispensation tip is one in which the dispensation tip is held and movably supported by an airtight and flexible material such as a diaphragm or a film. In this case, the cover includes a cover main body having stiffness and integrated with the reaction plate and an upper cover which is attached to the cover main body so as to be arranged above the top surface of the reaction plate and which is made of an airtight and flexible material, such as a diaphragm or a film, and holds and movably supports the dispensation tip. Further, the opening constituting a sample introduction unit is provided on the cover main body, and the sealing member for hermetically sealing the opening is to be stuck to the cover main body.

Another example of the structure for holding and movably supporting the dispensation tip is one in which the cover includes a cover main body integrated with the reaction plate and a cover plate arranged above the top surface of the reaction plate and held by the cover main body by means of a sealing material so as to be able to slide in a horizontal plane while the air tightness of the reaction container is kept, and the dispensation tip is held by the cover plate by means of another sealing material so as to be able to slide in a vertical direction while the air tightness of the reaction container is kept. Also in this case, the opening constituting a sample introduction unit is provided on the cover main body, and the sealing member for hermetically sealing the opening is to be stuck to the cover main body.

The reaction container kit according to the present invention can be used for measurements of various reactions such as chemical reactions and biochemical reactions.

Examples of a sample to be measured using the reaction container kit according to the present invention include, but are not particularly limited to, various samples such as chemical substances, biological samples, and living body-derived samples.

### EFFECTS OF THE INVENTION

In the reaction container kit according to the present invention, since the first bar code label to be read before sample dispensation is previously stuck to the reaction container and contains data indicating information unique to the reaction container, it is possible, by reading the first bar code label using a bar code reader before sample injection, to automatically determine whether or not the reaction container is a correct one suitable for an inspection item requested to be performed on a sample to be injected thereinto, thereby preventing an incorrect reaction container from being selected by human error.

Further, since the first bar code label is previously stuck to the reaction container and the second bar code label to be read after sample dispensation is provided so as to be able to be stuck to the reaction container, it is possible, by reading the bar code label stuck to the reaction container using a bar code reader, to determine whether or not a sample has already been injected into the reaction container, thereby preventing a sample from being injected again into the reaction container, into which the sample has already been injected, due to human error before the reaction container is attached to an inspection apparatus.

By allowing the first bar code label to be entirely or partially removed after data reading, it is possible to prevent the first bar code label from being kept stuck to the reaction container even after sample injection. In this case, whether or not sample injection has been carried out can be more reliably determined by the bar code label.

By allowing the reaction container to have an opening constituting a sample introduction unit and by previously sticking the first bar code label to the sample introduction unit so that the opening can be opened only after removing a portion of the first bar code label that should be removed, it is possible to reliably prevent the first bar code label from being kept stuck to the reaction container even after sample injection.

By allowing the second bar code label to also serve as a sealing member for hermetically sealing the opening after sample injection, it is possible to hermetically seal the inside of the reaction container with the second bar code label. This eliminates the necessity to prepare another sealing member for hermetically sealing the opening, which contributes to cost reduction.

In one embodiment of the reaction container kit according to the present invention, in which the space above the top surface of the reaction plate has, on the top surface side thereof, a reaction portion and a reagent container may be covered with a cover, and an opening constituting a sample introduction unit may be provided on the cover so that a sample can be introduced into the space covered with the cover from outside through the opening, by hermetically sealing the opening after the sample is introduced into the space covered with the cover, it is possible to prevent the entry of a foreign matter into the sample from outside and the pollution of a surrounding environment by a reaction product.

Further, in a case that a dispensation tip movably supported by the cover covering the space above the top surface of the reaction plate may be provided, by allowing the dispensation tip to have a syringe to be operated from the outside of the cover, it is possible to eliminate the necessity to additionally provide a nozzle mechanism.

By allowing the reaction plate to further have a gene amplification portion, it is possible to amplify a gene to be detected by gene amplification reaction such as PCR or LAMP even when the amount of the gene contained in a sample is very small and thereby to improve analytical accuracy.

By allowing the dispensation tip to have a filter inside the tip portion thereof, it is possible to prevent the entry of a foreign matter from outside through the dispensation tip even when the dispensation tip does not have a syringe. In addition, it is also possible to prevent the leakage of a reaction product into the outside through the dispensation tip and thereby to prevent the pollution of a surrounding environment.

In a case where gene amplification reaction is carried out, there is a problem that another DNA or the like will enter a sample from outside. Further, there is also a problem that another sample will be contaminated with an amplified gene. However, in the case of using the reaction container kit according to the present invention, it is possible to carry out gene amplification reaction in a closed space and to dispose of the reaction container kit with an amplified gene being trapped in the space after the completion of analysis, thereby preventing the contamination of a sample with a foreign matter entering from outside and eliminating the fear of contamination of another sample.

By allowing a reaction product to be analyzed in the reaction portion or in another site provided separately from the reaction portion in the reaction container, such as an electrophoresis portion or a region where probes which react with a gene are arranged, it is possible to increase the types of samples which can be treated using the reaction container kit according to the present invention.

The structure for holding and movably supporting the dispensation tip can be easily achieved by, for example, using an airtight and flexible material or a cover constituted from a cover main body and a cover plate. In the latter case, the dispensation tip is supported so as to be able to be moved by sliding the cover plate supported by the cover main body and by sliding the dispensation tip itself supported by the cover plate.

### BRIEF DESCRIPTION OF THE DRAWINGS

FIG. 1A is an external perspective view of a reaction container kit according to one embodiment of the present invention, into which a sample has not yet been injected.

FIG. 1B is an external perspective view of the reaction container kit according to the embodiment shown in FIG. 1A, from which a first bar code label has been removed for sample injection.

FIG. 1C is an external perspective view of the reaction container kit according to the embodiment shown in FIG. 1A, to which a second bar code label has been stuck after sample injection.

FIG. 2A is a vertical sectional view showing the internal structure of the reaction container kit according to the embodiment shown in FIG. 1A.

FIG. 2B is a plan view showing a reaction plate and a dispensation tip of the reaction container kit shown in FIG. 2A.

FIG. 2C is a sectional view schematically showing another example of the dispensation tip.

FIG. 3 is a vertical sectional view of the reaction container kit according to the embodiment shown in FIG. 1A, into which a sample has been introduced.

FIG. 4 is a vertical sectional view of the reaction container kit according to the embodiment shown in FIG. 1A, in which a syringe drive section of a drive unit has been engaged with a plunger of a syringe.

FIG. 5 is a vertical sectional view of the reaction container kit according to the embodiment shown in FIG. 1A, in which a tip holding section of the drive unit has been engaged with the dispensation tip.

FIG. 6 is a vertical sectional view of the reaction container kit according to the embodiment shown in FIG. 1A, from which the dispensation tip has been disengaged from the holding section.

FIG. 7 is a vertical sectional view of a first example of a detection unit for use in detecting a reaction product contained in the reaction container kit according to the present invention.

FIG. 8 is a vertical sectional view of a second example of a detection unit for use in detecting a reaction product contained in the reaction container kit according to the present invention.

FIG. 9 is a vertical sectional view of a third example of a detection unit for use in detecting a reaction product contained in the reaction container kit according to the present invention.

FIG. 10A is a vertical sectional view of another embodiment of the reaction container kit according to the present invention.

FIG. 10B is a plan view showing a reaction plate and a dispensation tip of the reaction container kit shown in FIG. 10A.

FIG. 11 is a vertical sectional view showing an example of a detection unit for use in detecting a reaction product contained in the reaction container kit according to the embodiment shown in FIG. 10A and a reaction container of the reaction container kit.

FIG. 12A is a vertical sectional view of yet another embodiment of the reaction container kit according to the present invention.

FIG. 12B is a plan view showing a reaction plate and a dispensation tip of the reaction container kit shown in FIG. 12A.

FIG. 13 is a vertical sectional view showing an example of a detection unit for use in detecting a reaction product contained in the reaction container kit according to the embodiment shown in FIG. 12A and a reaction container of the reaction container kit.

FIG. 14 is a vertical sectional view showing yet another embodiment of the reaction container kit according to the present invention and an example of a detection unit for use in detecting a reaction product.

FIG. 15 is a vertical sectional view of yet another embodiment of the reaction container kit according to the present invention

FIG. 16A is a vertical sectional view of yet another embodiment of the reaction container kit according to the present invention.

FIG. 16B is a plan view showing a reaction plate and a dispensation tip of the reaction container kit shown in FIG. 16A.

FIG. 16C is an external perspective view of the reaction container kit shown in FIG. 16A.

FIG. 17A is a vertical sectional view of yet another embodiment of the reaction container kit according to the present invention.

FIG. 17B is a plan view showing a reaction plate and a dispensation tip of the reaction container kit shown in FIG. 17A.

FIG. 17C is an external perspective view of the reaction container kit shown in FIG. 17A.

FIG. 18A is a vertical sectional view of yet another embodiment of the reaction container kit according to the present invention.

FIG. 18B is a plan view showing a reaction plate and a dispensation tip of the reaction container kit shown in FIG. 18A.

FIG. 18C is an external perspective view of the reaction container kit shown in FIG. 18A.

FIG. 19A is a vertical sectional view of yet another embodiment of the reaction container kit according to the present invention.

FIG. 19B is a plan view showing a reaction plate and a dispensation tip of the reaction container kit shown in FIG. 19A.

FIG. 19C is an external perspective view of the reaction container kit shown in FIG. 19A.

FIG. 20 is a perspective view schematically showing the inside of one example of a reaction container treatment apparatus.

FIG. 21 is a block diagram showing the control system of the reaction container treatment apparatus shown in FIG. 20.

### DESCRIPTION OF THE REFERENCE NUMERALS

| 2, 2a, 2b, 2c | reaction plate |
|---|---|
| 3 | substrate |
| 4 | reaction portion |
| 12 | reagent container |
| 14 | film |
| 20 | dispensation nozzle |
| 22 | plunger of syringe |
| 23 | filter |
| 24 | cover |
| 26 | cover main body |
| 28 | bellows film |
| 32, 32a | sample container |
| 64, 64a, 71 | cover plate |
| 66, 68, 72 | sealing material |
| 100, 110, 120 | DNA chip |
| 106 | electrode |
| 102 | flow path for electrophoretic separation |
| 130 | first bar code label |
| 134 | second bar code label |
| 138 | part of first bar code label |

### DETAILED DESCRIPTION OF THE INVENTION

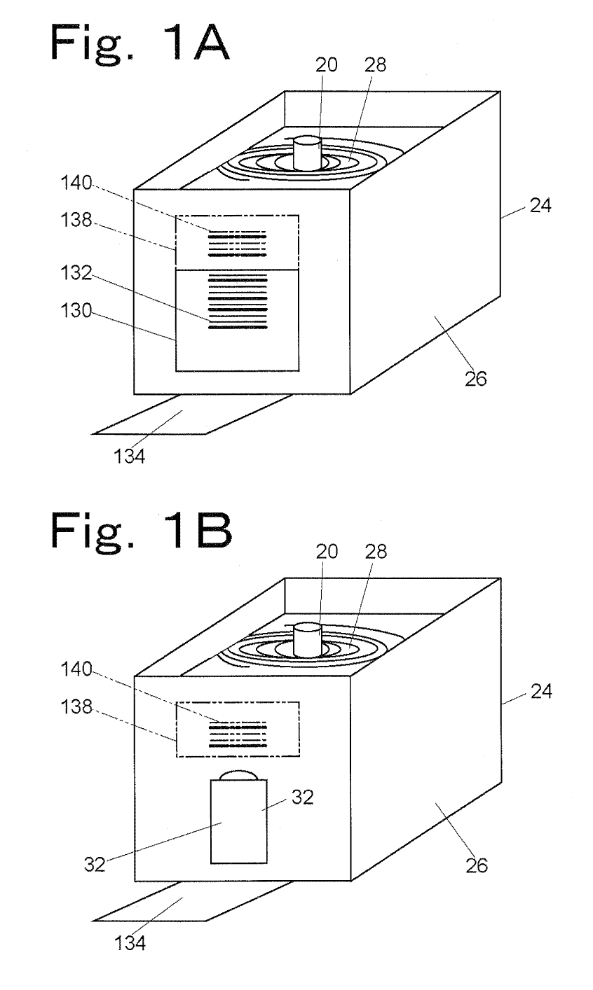

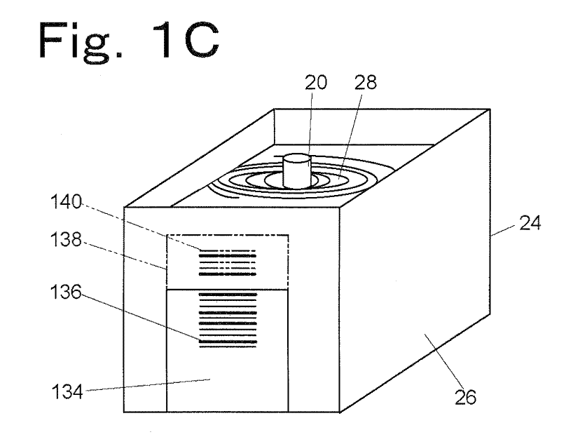

FIG. 1A is a perspective view of a reaction container kit according to one embodiment of the present invention, into which a sample has not yet been injected, FIG. 1B is a perspective view of the reaction container kit according to the embodiment shown in FIG. 1A, from which a first bar code label has been removed for sample injection, and FIG. 1C is a perspective view of the reaction container kit according to the embodiment shown in FIG. 1A, to which a second bar code label has been stuck after sample injection. FIG. 2A is a vertical sectional view concretely showing the internal structure of the reaction container kit according to the embodiment shown in FIG. 1A, FIG. 2B is a plan view showing a reaction plate and a dispensation tip 20 of the reaction container kit shown in FIG. 2A, and FIG. 2C is a sectional view schematically showing another example of the dispensation tip.

As shown in FIGS. 2A and 2B, a reaction plate 2 has, on the top surface side of a substrate 3, a reaction portion 4 for carrying out the reaction of a sample and reagent containers 12 containing a reagent for use in the reaction of a sample and sealed with a film 14.

The reaction portion 4 is provided as a recess in the top surface of the substrate 3. In a case where the reaction portion 4 is intended for reaction carried out under externally-controlled temperature conditions, a part of the reaction portion 4 subjected to temperature control preferably has a small thickness to enhance heat conductivity.

Each of the reagent containers 12 is also provided as a recess on the top surface of the substrate 3, and contains a reagent to be used for reaction, and is covered with the film 14 through which the dispensation tip 20 (which will be described later) can pass. Examples of such a film 14 include an aluminum foil and a laminated film having an aluminum film and a resin film such as a PET (polyethylene terephthalate) film. The film 14 is attached by welding or adhesion so as not to be easily detached.

If necessary, a mixing chamber for mixing a sample with a reagent may be provided as a recess in the top surface of the substrate 3. Further, such a mixing chamber may be covered with the film 14 with its recess being empty.

The reaction portion 4 may be used as a detection chamber for detecting a reaction product formed in the reaction portion 4. In this case, detection of a reaction product can be carried out by, for example, means for externally irradiating the reaction portion 4 with light. Alternatively, a detection chamber may be provided separately from the reaction portion 4. For example, in a case where a plurality of detection chambers are provided separately from the reaction portion 4, the detection chambers may previously contain different reagents for detecting the state of a reaction mixture obtained by the reaction of a sample with a reagent, and the reaction mixture is dispensed into the detection chambers by the dispensation tip 20. The opening of such a detection chamber may be covered with a film through which the dispensation tip 20 can pass. As in the case of the film 14, examples of the film for covering the detection chamber include an aluminum foil and a laminated film having an aluminum film and a resin film such as a PET film, and the film can be attached by welding or adhesion so as not to be easily detached.

The material of the substrate 3 having the reaction portion 4 is not particularly limited, but is preferably cheaply available because the reaction container is disposable. Preferred examples of such a material include resin materials such as polypropylene and polycarbonate. In a case where the reaction container is designed to allow a reaction product to be detected by absorbance, fluorescence, chemiluminescence, or bioluminescence in the reaction portion 4 or a detection chamber provided separately from the reaction portion 4, the substrate 3 is preferably made of an optically-transparent resin so that the reaction product can be optically detected from the bottom surface side of the substrate 3. Particularly, in a case where a reaction product is detected by fluorescence, the substrate 3 is preferably made of a low self-fluorescence (i.e., the amount of fluorescence emitted from a material itself is small) and an optically-transparent resin such as polycarbonate. The thickness of the substrate 2 is in the range of 0.3 to 4 mm, preferably in the range of 1 to 2 mm. From the viewpoint of low self-fluorescence, the thickness of the substrate 3 is preferably small.

The dispensation tip 20 is arranged above the top surface of the reaction plate 2. The dispensation tip 20 is used to dispense a sample and a reagent. Further, in a case where the reaction plate 2 has a detection chamber provided separately from the reaction portion 4, the dispensation tip 20 is used also to dispense a reaction mixture obtained by reacting a sample with a reagent into the detection chamber. The dispensation tip 20 has a syringe 22, and the syringe 22 is driven from the outside of a cover 24 to carry out dispensation operation.

As shown in FIG. 2C, the dispensation tip 20 may have a filter 23 in its inside instead of the syringe 22. The filter adsorbs foreign matter entering from the outside, and is therefore more effective to prevent the entry of foreign matter into a space covered with the cover 24 and to prevent the release of reactants and a reaction product from the space covered with the cover 24 into the outside.

The cover 24 is provided so as to cover a space above the top surface of the reaction plate 2. The cover 24 includes a cover main body 26 for covering the periphery of the reaction plate 2 and a bellows film 28 for covering the top of the reaction plate 2 so that a space above the top surface of the reaction plate 2 is cut off from the outside. The cover main body 26 is provided integrally with the reaction plate 2 by fixing the lower end of the cover main body 26 to the reaction plate 2 or by using a sealant provided between the lower end of the cover main body 26 and the reaction plate 2, and has stiffness to maintain the shape of the cover 24. The bellows film 28 is formed from a flexible diaphragm or a flexible film, and movably holds the dispensation tip 20 so that a distal end thereof is located inside a space covered with the cover 24 and a proximal end thereof is located outside the space covered with the cover 24.

The material of the cover 24 is not particularly limited as long as it can cover a space above the top surface of the reaction plate 2 while keeping the reaction container kit hermetically sealed. However, the cover 24 is preferably made of a cheaply-available material because the reaction container is disposable. Preferred examples of a material for forming the cover main body 26 include resin materials such as polypropylene and polycarbonate, and preferred examples of a material for forming the bellows film 28 include Nylon®, polyvinyl chloride, and rubber materials such as silicone rubber and the like.

A holding member 30 for holding the dispensation tip 20 before and after its use is provided on the cover main body 26 or the substrate 3. When used for dispensation operation, the dispensation tip 20 is detached from the holding member 30 so as to be freely moved over the top surface of the reaction plate 2.

A cover main body 26 has an opening 31 for introducing a sample from the outside of a cover 24 into the reaction plate 2, and a sample container 32 is attached to the opening 31 so that the opening 31 can be opened and closed. The opening 31 and the sample container 32 constitute a sample introduction unit.

As shown in FIG. 1A, before the sample container kit is used, that is, before sample dispensation is carried out, the reaction container has a first bar code label 130 previously stuck to the outside of the cover main body 26 so as to cover the sample container 32. The first bar code label 130 is designed to be read before the dispensation of a sample into the reaction container, and has a bar code 132 containing data indicating information unique to the reaction container and data indicating that a sample has not yet been injected into the reaction container.

Before sample injection, the bar code 132 of the first bar code label is read by a bar code reader to automatically determine whether or not the reaction container is a correct one suitable for an inspection item requested to be performed on a sample to be injected thereinto and to confirm that a sample has not yet been injected into the reaction container.

As described above, since the first bar code label 130 is stuck so as to cover the sample container 32, the opening 31 can be opened only by removing the first bar code label 130.

The reaction container further has a second bar code label 134 to be read after sample dispensation. The second bar code label 134 is partially attached to the reaction container with the adhesive-coated surface thereof being covered with a release sheet so as to be able to be stuck to the reaction container. The release sheet is removed when the second bar code label 134 is stuck to the reaction container, and the second bar code label 134 is stuck so as to cover the sample container 32. As a result, the opening 31 is hermetically sealed. The second bar code label 134 has a bar code 136 (see FIG. 1C) containing data indicating that a sample has already been injected into the reaction container.

The back surface of each of the bar code labels 130 and 134 (a surface having a bar code printed thereon is defined as a front surface) is an adhesive-coated surface. Specific examples of the bar code labels 130 and 134 include labels obtained by applying an adhesive onto a base material. Examples of the base material include polyethylene film, polypropylene film, polystyrene film, synthetic paper, polyimide film, and film for variable information labeling. Examples of the adhesive to be applied onto the base material include PVA-based emulsions, SBR-based emulsions, acrylic emulsions, synthetic rubber-based emulsions, pressure-sensitive adhesives, and heat-sensitive adhesives. As described above, since the bar code label 130 is removed at the time of sample injection, the adhesive to be applied onto the base material is preferably a pressure-sensitive adhesive which makes it possible to easily remove the bar code label.

The sample container 32 has a recess facing upward to receive an injected sample. After a sample is injected into the recess, the sample container 32 is placed inside the cover 24 so that the opening 31 is closed by a plate 34 holding the sample container 32. Then, the release sheet attached to the adhesive-coated surface of the bar code label 134 is removed, and the bar code label 134 is stuck to the cover main body 26 so as to cover the plate 34. As a result, the opening 31 is hermetically sealed with the bar code label 134.

The reaction container is disposable, and therefore the entire reaction container is disposed of with the reaction plate 2 being covered with the cover 24 after the completion of the analysis of one sample.

Hereinafter, a process for analyzing a sample using the reaction container kit according to the above-described embodiment of the present invention will be described.

The unused reaction container is supplied in such a state as shown in FIG. 1A. Before sample injection, the bar code 132 of the first bar code label is read by a bar code reader to automatically determine whether or not the reaction container is a correct one suitable for an inspection item requested to be performed on a sample to be injected thereinto. When the reaction container is determined to be a correct one, the first bar code label 130 is removed so that the sample container 32 appears as shown in FIG. 1B. Then, the sample container 32 is pulled out to inject a sample thereinto, and is then again placed inside the reaction container.

Then, as shown in FIG. 1C, a release sheet attached to the second bar code label 134 is removed to stick the second bar code label 134 to the sample container 32. As a result, the opening 31 is hermetically sealed with the second bar code label 134, and therefore the sample introduced into a space covered with the cover 24 of the reaction container is cut off from the outside.

As described above, since the second bar code label 134 has the bar code 136 containing data indicating that a sample has already been injected into the reaction container, it is possible, by reading the bar code 136 using a bar code reader, to automatically confirm that a sample has already been injected into the reaction container.

A bar code label 138 shown in FIG. 1A by a dotted line is a part of a first bar code label according to another embodiment of the present invention. In this case, the first bar code label is composed of a portion 130 to be removed and a portion 138 not to be removed even at the time of sample injection. The portion 138 to be kept stuck to the reaction container without being removed therefrom has a bar code 140 containing data indicating information unique to the reaction container, such as an inspection item to be performed using the reaction container, and the portion 130 to be removed has a bar code 132 containing data indicating that a sample has not yet been injected into the reaction container. A sample injection method to be used in this case is the same as that used in the case of the reaction container not having a portion 138. However, the portion 138 is kept stuck to the reaction container without being removed therefrom even after sample injection.

In the drawings of other embodiments according to the present invention which will be described below, the bar code labels are not shown. However, also in each of the following embodiments according to the present invention, as in the case of the embodiment shown in FIG. 1, the first bar code label 130 is previously stuck to the outside of the cover main body so as to cover the sample container, and the second bar code label 134 is partially attached to the reaction container so as to be able to be stuck to the reaction container. Further, the first bar code label may have a portion 138 to be kept stuck to the reaction container.

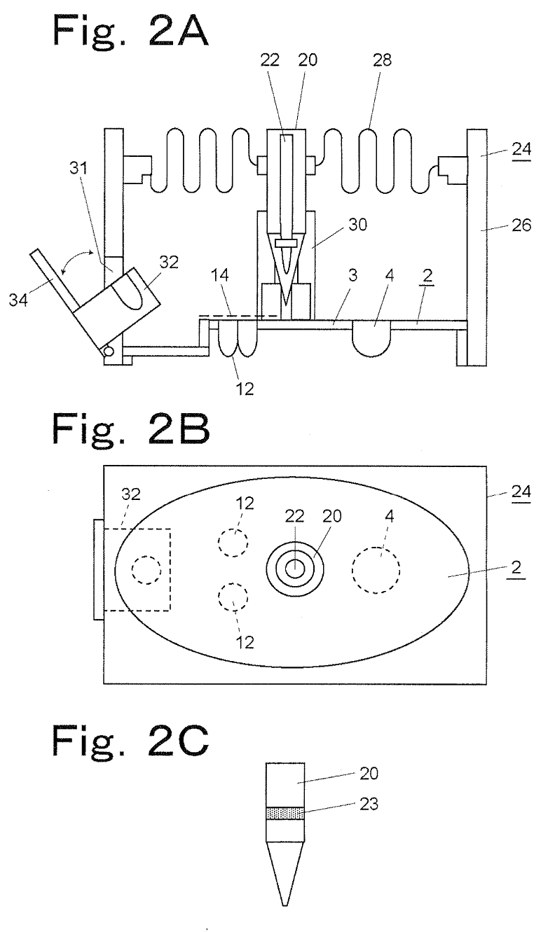

After the sample is introduced into the reaction container kit, as shown in FIG. 3, engagement of a drive unit 36 with the dispensation tip 20 and the syringe 22 is allowed to start.

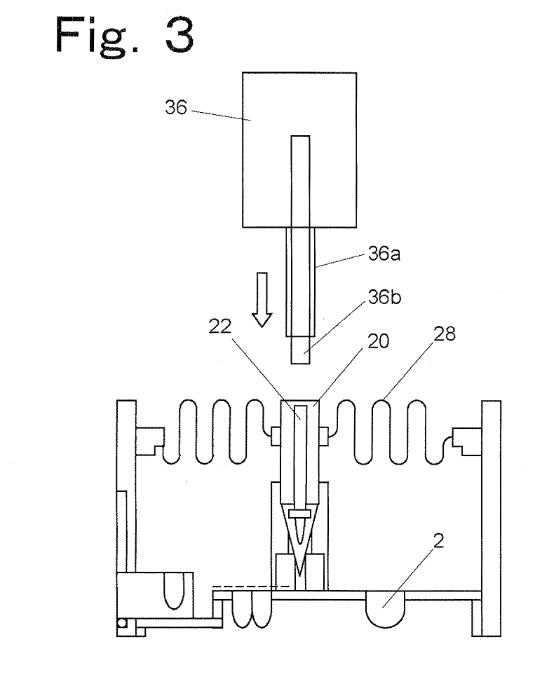

First, as shown in FIG. 4, a plunger holder 36b as a syringe drive section is moved down to be engaged with a plunger of the syringe 22.

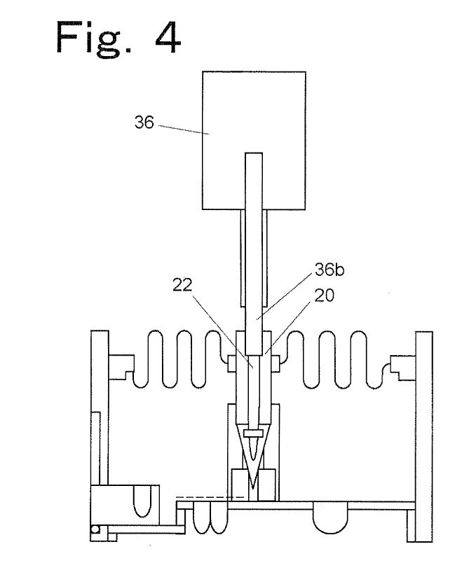

Then, as shown in FIG. 5, a tip holder 36a is also moved down to be press-fitted to the dispensation tip 20 so that the dispensation tip 20 is held by the tip holder 36a.

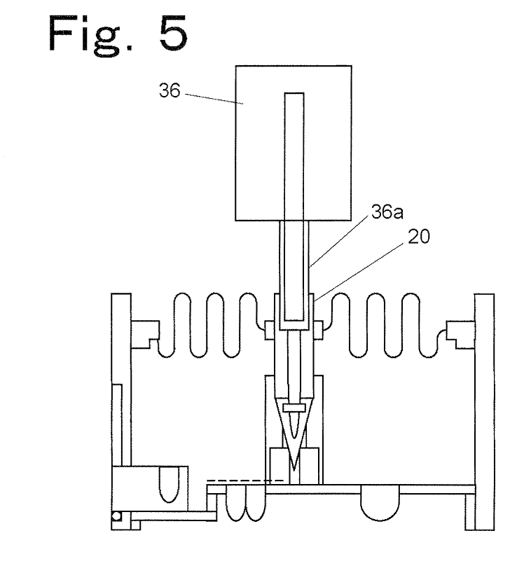

Next, as shown in FIG. 6, the dispensation tip 20 is detached from the holding section 30. In this way, the dispensation tip 20 becomes able to be freely moved by the bellows film 28 with its distal end being cut off from the outside.

The dispensation tip 20 is moved to the sample container 32 to take a sample, and then the sample is dispensed into the reaction portion 4 by the dispensation tip 20.

Then, the dispensation tip 20 is moved to the reagent container 12, and the distal end of the dispensation tip 20 is passed through the film 14 to take a reagent from the reagent container 12, and the reagent is dispensed into the reaction portion 4 by the dispensation tip 20 to react the sample with the reagent. If necessary, the reaction portion 4 is brought into contact with an external heat source during the reaction to adjust the temperature of the reaction portion 4 to a predetermined temperature.

During or after the reaction, detection of a reaction product is carried out. In this case, it is assumed that a reaction product contained in the reaction portion 4 is optically detected from the outside of the reaction plate 2. Therefore, a detection unit is arranged below the reaction portion 4 to detect a reaction product by optical means or other means.

As described above, the reaction plate 2 of the embodiment has reagent containers 12, but the reagent containers 12 can be omitted from the reaction plate 2. In this case, both a sample and a reagent may be injected into the sample container 32 to introduce them into the reaction container, or another container not shown may be used to introduce a reagent into the reaction container.

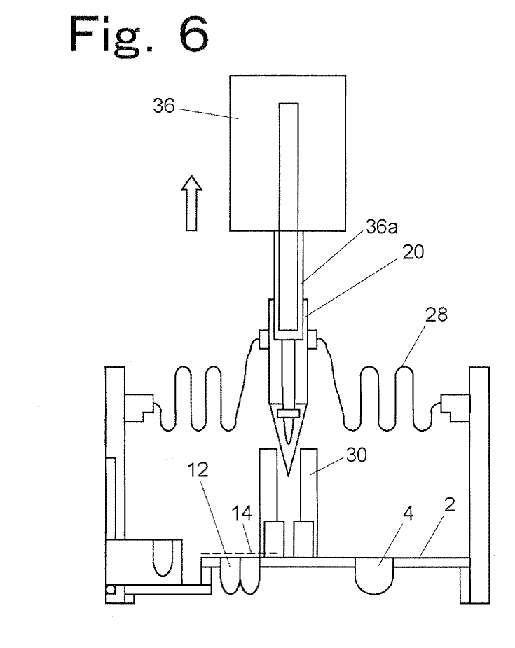

FIGS. 7 to 9 show examples of a detection unit to detect a reaction product in the reaction container of the reaction container kit according to the present invention.

FIG. 7 shows an example of the detection unit including an absorbance detector. In this case, the reaction portion 4 preferably has a pair of parallel flat surfaces serving as a light incident surface through which measuring light enters and a light exiting surface through which measuring light exits.

A detection unit 38a includes an irradiation optical system. The irradiation optical system has, on its optical path, a light source 40a, a pair of lenses 42a for once condensing light emitted from the light source 40a to obtain parallel light and then condensing the parallel light to irradiate the reaction portion 4 with condensed light, a filter 44a arranged between the pair of lenses 42a at a position where the parallel light travels to select light having a predetermined wavelength from light emitted from the light source 40a to obtain measuring light, and mirrors 46 for guiding the measuring light to the light incident surface of the reaction portion 4. As the light source 40a, a lamp light source such as a tungsten lamp which emits light having wavelengths ranging from the ultraviolet light region to the visible light region, a light-emitting diode (LED), a laser diode (LD), or the like is used. Further, the detection unit 38a includes a light-receiving optical system. The light-receiving optical system has, on its optical path, a photodetector 48a, mirrors 50 for guiding light exiting from the reaction portion 4 through its light exiting surface to the photodetector 48a, a pair of lenses 52 for once converting the light into parallel light and then condensing the parallel light to introduce condensed light into the photodetector 48a, and a filter 54a arranged between the pair of lenses 52 at a portion where the parallel light travels to select light having a predetermined wavelength suitable for measurement.

The reason for once converting light into parallel light by the lenses 42a and 52a is to improve the precision of wavelength selection by the filters 44a and 54a.

In the case of using such a detection unit 38a, light having a wavelength suitable for detecting a reaction product is selected from light emitted from the light source 40a by the filters 44a and 54a, and absorbance is measured at the selected wavelength to detect the reaction product.

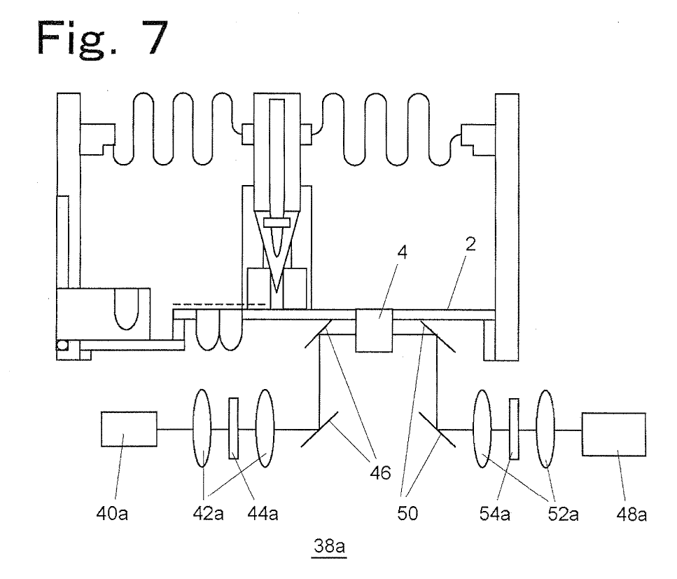

FIG. 8 shows an example of a detection unit including a fluorescence detector.

A detection unit 38b includes an excitation optical system. The excitation optical system has a light source 40b, a pair of lenses 42b for once condensing light emitted from the light source 40b to obtain parallel light and then condensing the parallel light to irradiate the reaction portion 4 with condensed light, and a filter 44b arranged on the optical path of parallel light beams obtained by the lens 42b to select light having a predetermined excitation wavelength from light emitted from the light source 40b. Further, the detection unit 38b includes a light-receiving optical system. The light-receiving optical system has a photodetector 48b, a pair of lenses 52b for receiving fluorescence emitted from the reaction portion 4, once converting the fluorescence into parallel light, and condensing the parallel light to introduce condensed light into the photodetector 48b, and a filter 54b arranged on the optical path of the parallel fluorescence beams obtained by the lens 52b to select light having a predetermined fluorescence wavelength. Similarly, the reason for once converting light into parallel light by the lenses 42b and 52b is to improve the precision of wavelength selection by the filters 44b and 54b.

In the case of using such a detection unit 38b, light having an excitation wavelength for exciting a reaction product is selected from light emitted from the light source 40b by the filter 44b to irradiate the reaction product contained in the reaction portion 4 with the selected light, and fluorescence emitted from the reaction product is received by the light-receiving optical system, and light having a predetermined fluorescence wavelength is selected by the filter 54b, and the selected fluorescence is detected by the photodetector 48b.

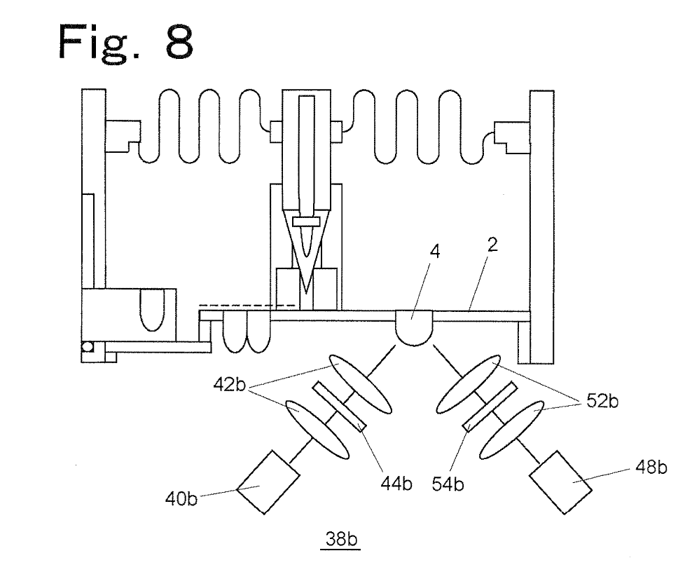

FIG. 9 shows an example of the detection unit for detecting chemiluminescence or bioluminescence emitted from a reaction product.

A detection unit 38c has a photodetector 48c for detecting light emitted from the reaction portion 4, a lens 52c for receiving light emitted from the reaction portion 4 and guiding condensed light to the photodetector 48c, and a filter 54c for selecting light having a predetermined emission wavelength from the condensed light.

In the case of using such a detection unit 38c, chemiluminescence or bioluminescence emitted from a reaction product contained in the reaction portion 4 is condensed by the lens 52c, and light having a predetermined emission wavelength is selected by the filter 54c, and the selected light is detected by the photodetector 48c.

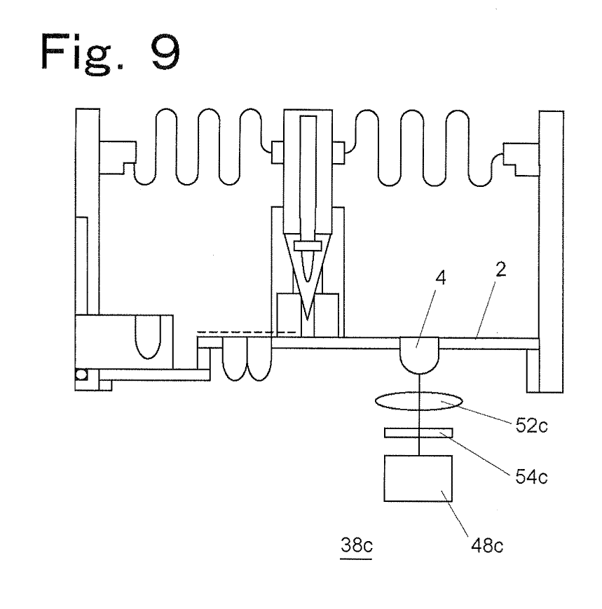

FIGS. 10 to 14 show other embodiments different in the structure of the reaction plate. The reaction plate of the embodiment described above is designed to allow a reaction product to be detected in the reaction portion 4, but the reaction plate of each of the embodiments shown in FIGS. 10 to 14 further has an analysis section for analyzing a reaction product.

A reaction plate 2a of the embodiment shown in FIG. 10 has an electrophoresis section as the analysis section. In this case, an electrophoresis chip 100 is used as one example of the electrophoresis section. The electrophoresis chip 100 has a reaction product injection section 103, an electrophoretic separation channel 102, and electrodes 106a to 106d for applying an electrophoresis voltage. The electrophoresis chip 100 further has, in addition to the electrophoretic separation channel 102, a sample introduction channel 104 arranged so as to cross the channel 102 to introduce a sample into the channel 102, but the sample introduction channel 104 may have such a structure that a sample can be directly introduced thereinto from one end of the channel 102. The electrophoresis chip 100 is subjected to fluorescence detection from the back surface side thereof, and is therefore made of a low self-fluorescence and an optically-transparent resin such as polycarbonate, glass, or quartz.

The reaction plate 2a further has a separation buffer container 15 provided in the top surface thereof to receive a separation buffer to be injected into the channels 102 and 104. The separation buffer container 15 is sealed with a film through which the tip of the dispensation tip 20 can pass.

The electrodes 106a to 106d for applying an electrophoresis voltage are connected to both ends of the channel 102 and 104, respectively. These electrodes 106a to 106d are extended to the outside of the cover 24 so as to be connected to a power supply provided outside the reaction container.

Each of the channels 102 and 104 has a reservoir at its end, and a separation buffer contained in the separation buffer container 15 is injected into the reservoirs.

In a case where the embodiment is used for gene analysis, the reagent container 12 is allowed to previously contain a PCR reaction reagent. In this case, the reaction portion 4 serves as a PCR reaction container.

In a case where a gene sample is measured using the reaction container kit of the embodiment, a sample is introduced into the sample container 32, and then the reaction container is attached to the reaction container kit treatment equipment. In the reaction container kit treatment equipment, the sample contained in the sample container 32 is dispensed into the reaction portion 4 by the dispensation tip 20, and then a PCR reaction reagent contained in the reagent container 12 is also dispensed into the reaction portion 4 by the dispensation tip 20. Further, mineral oil (not shown) is layered over a mixture of the sample and the reagent contained in the reaction portion 4, and then PCR reaction is carried out by controlling the temperature of the reaction mixture contained in the reaction portion 4 according to a predetermined temperature cycle.

A separation buffer is supplied by the dispensation tip 20 from the separation buffer container 15 to the channels 102 and 104 through the reservoirs in the electrophoresis chip 100.

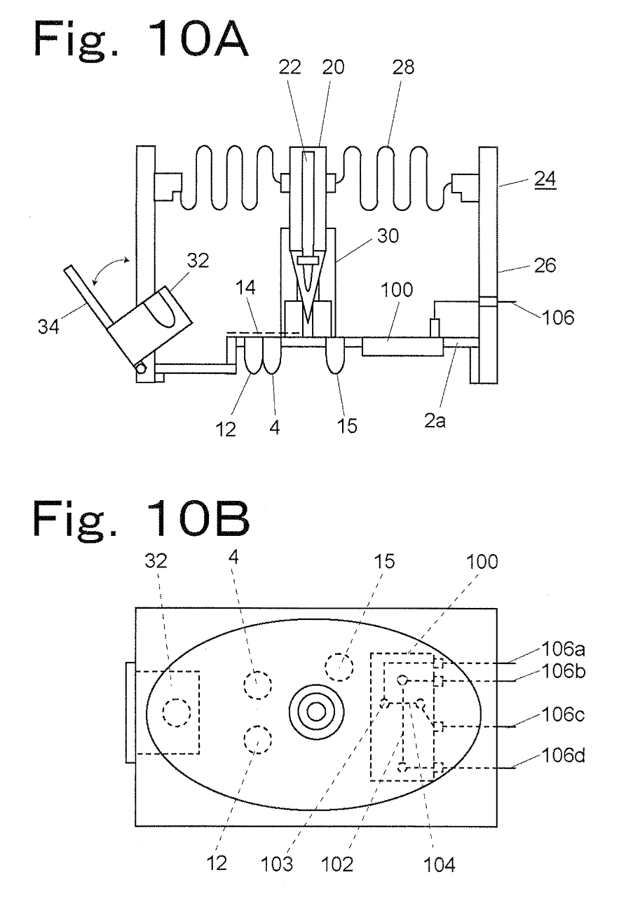

After the completion of the PCR reaction, an obtained reaction mixture is supplied as a sample by the dispensation tip 20 from the reaction portion 4 to the injection section 103 of the electrophoresis chip 100 having the separation buffer previously supplied. Then, a voltage is applied from a power supply 101 (see FIG. 11) provided in the reaction container kit treatment equipment to the channels 102 and 104 through the electrodes 106a to 106d to introduce the sample into the electrophoretic separation channel 102, and then the sample is electrophoresed in the channel 102 to be separated into its components.

In order to detect sample components separated by electrophoresis, the reaction container kit treatment equipment has a detection unit 38d.

It is to be noted that in this case, the reaction portion 4 is used as a PCR reaction container, but a PCR reaction container may be provided separately from the reaction portion 4.

The detection unit 38d is shown in FIG. 11. The detection unit 38d includes an excitation optical system and a fluorescence-receiving optical system to carry out fluorescence detection of sample components passing through a predetermined position in the electrophoretic separation channel 102. Since the detection unit 38d detects the fluorescence of sample components passing through a fixed position, it is not necessary to move the detection unit 38d.

The excitation optical system has a light source 40c, a lens 42c for condensing light emitted from the light source 40c to obtain parallel light, and a filter 44c provided on the optical path of parallel light beams obtained by the lens 42c to select light having a predetermined excitation wavelength from light emitted from the light source 40c.

The detection unit 38d further includes a dichroic mirror 53 and an objective lens 55 to irradiate a predetermined position in the electrophoretic separation channel 102 with excitation light obtained by the excitation optical system from the back surface side of the electrophoresis chip 100 and to receive fluorescence emitted from the position and convert it into parallel light. It is to be noted that the dichroic mirror 53 is designed so as to reflect light having an excitation wavelength to be used for the embodiment and transmit light having a fluorescence wavelength.

The fluorescence-receiving optical system of the detection unit 38d is arranged at a position where it can receive fluorescence converted into parallel light by the objective lens 55 and passed through the dichroic mirror 53. The fluorescence-receiving optical system has a filter 54c for selecting light having a predetermined fluorescence wavelength from fluorescence passed through the dichroic mirror 53 and a lens 52c for condensing the fluorescence having a wavelength selected by the filter 54c to introduce condensed light into a detector 48c. As described above, the reason for once converting light into parallel light by the lenses 42c and 55 is to improve the precision of wavelength selection by the filters 44c and 54c.

In the case of using such a detection unit 38d, light having an excitation wavelength for exciting a reaction product is selected by the filter 44c from light emitted from the light source 40c to irradiate the reaction product passing through a predetermined position in the electrophoretic separation channel 102 with the light, and fluorescence emitted from the reaction product is received by the light-receiving optical system, and light having a predetermined fluorescence wavelength is selected by the filter 54c and detected by the photodetector 48c.

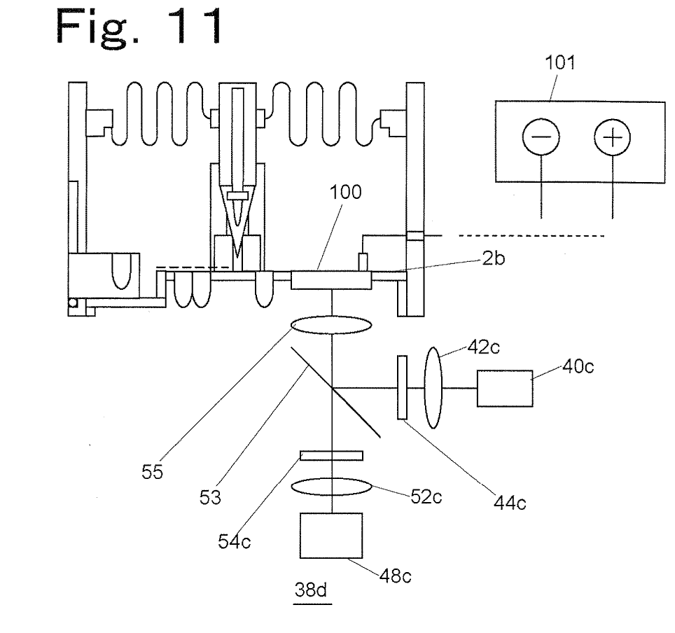

A reaction plate 2b of the embodiment shown in FIG. 12 has a DNA chip 110 as the analysis section. When a reaction product contains a gene, probes, which react with the gene, are immobilized to the DNA chip 110. The DNA chip 110 is subjected to fluorescence detection from the back surface side thereof, and is therefore made of a low self-fluorescence and an optically-transparent resin such as polycarbonate or glass.

The reaction plate 2a further has cleaning solution containers 17 formed in the top surface thereof. The cleaning solution containers 17 contain a cleaning solution for separating and removing the reaction product not having been bound to the probes from the reaction product having been bound to the probes in the DNA chip 110. Further, the cleaning solution containers 17 are sealed with a film through which the tip of the dispensation tip 20 can pass.

In a case where the embodiment is used for gene analysis, the reagent container 12 is allowed to previously contain a PCR reaction reagent. In this case, the reaction portion 4 serves as a PCR reaction container.

In a case where a gene sample is measured using the reaction container kit of the embodiment, the sample is introduced into the sample container 32, and then the reaction container is attached to the reaction container kit treatment equipment. In the reaction container kit treatment equipment, the sample contained in the sample container 32 is dispensed into the reaction portion 4 by the dispensation tip 20, and then a PCR reaction reagent contained in the reagent container 12 is also dispensed into the reaction portion 4 by the dispensation tip 20. Further, mineral oil (not shown) is layered onto a mixture of the sample and the reagent contained in the reaction portion 4, and then PCR reaction is carried out by controlling the temperature of the mixture contained in the reaction portion 4 according to a predetermined temperature cycle.

After the completion of the PCR reaction, an obtained reaction mixture is supplied as a sample from the reaction portion 4 to the DNA chip 110 by the dispensation tip 20. After the completion of incubation, a cleaning solution is supplied from the cleaning solution container 17 to the DNA chip 110 by the dispensation tip 20, and then a reaction product not having been bound to the probes is removed by sucking the cleaning solution into the dispensation tip 20.

The reaction product having been bound to the probes can be detected by fluorescence by previously labeling the reaction product with a fluorescent material. The detection of the presence of fluorescence in the DNA chip 110 indicates that a gene corresponding to the probe immobilized at a position where fluorescence has been detected is contained in the sample.

In order to detect the reaction product having been bound to the probes in the dispensation tip 20, the reaction container kit treatment equipment includes a detection unit 38e.

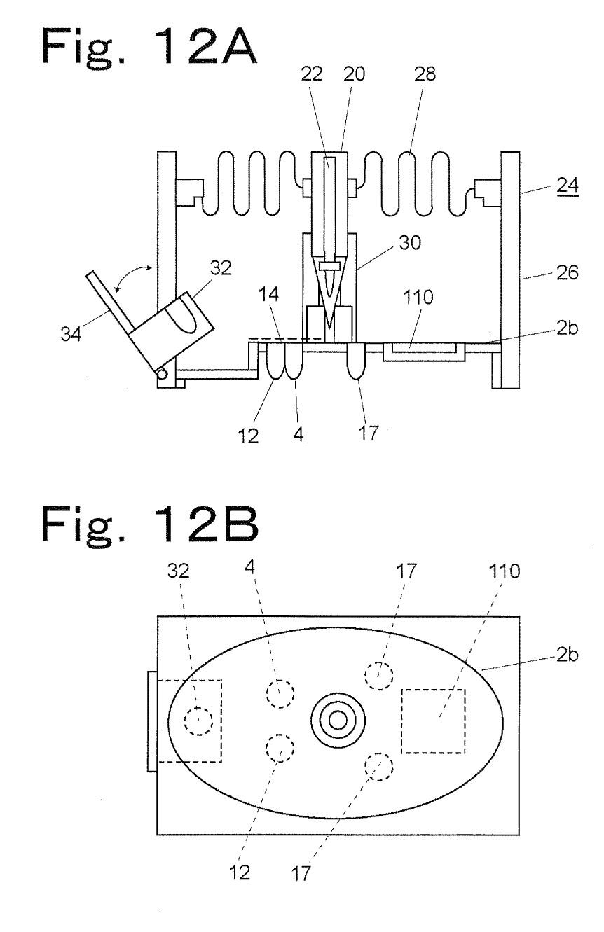

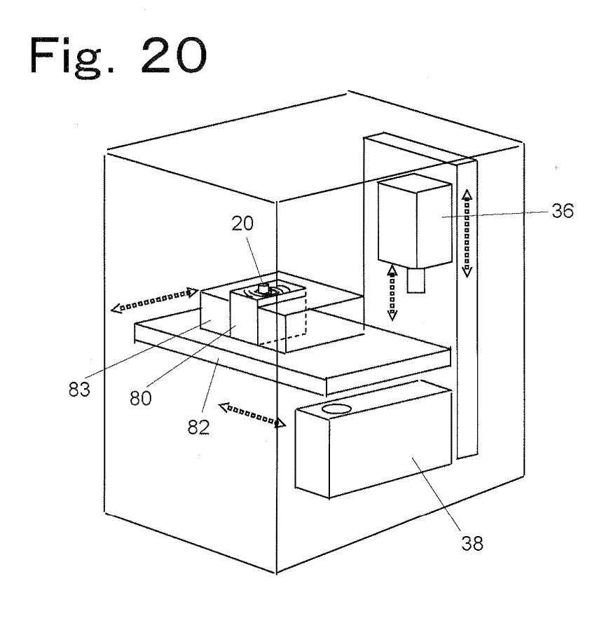

The detection unit 38e is shown in FIG. 13. The structure of an optical system of the detection unit 38e is the same as that of the detection unit 38d shown in FIG. 11, and therefore the description thereof is omitted. The detection unit 38e is different from the detection unit 38d shown in FIG. 11 in that it is movably supported so that fluorescence detection can be carried out for all the probes arranged in the DNA chip 110. Such detection can be achieved, as shown in FIG. 20, by allowing a table 82 to move in the X direction and by allowing the detection unit 38e to move in the Y direction.

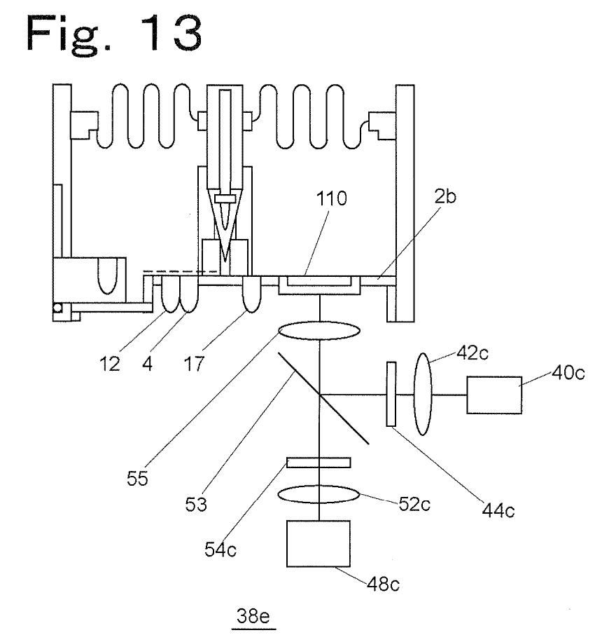

A reaction plate 2c of the embodiment shown in FIG. 14 has a DNA chip 120 as the analysis section. The DNA chip 120 is different from the DNA chip 110 of the embodiment shown in FIG. 12 in that it is designed to allow a reaction product to be detected not by fluorescence detection but by electric detection. The DNA chip 120 utilizes a phenomenon in which the current value of each probe varies depending on whether a sample gene has been bound to the probe or not. Since the DNA chip 120 is not subjected to optical detection, the material of the DNA chip 120 does not need to be optically transparent but needs to be electrically insulating.

When a reaction product contains a gene, probes, which react with the gene, are immobilized to the DNA chip 120. Each of the probes is connected to an electrode provided on the back surface of the reaction plate so that the current value thereof can be measured. In the case of using the embodiment, it is not necessary to previously label a sample with a fluorescent material.

The electrodes provided on the back surface of the reaction plate and connected to the probes are connected also to a detector 122 provided in the reaction container kit treatment equipment to measure the current value of each of the probes to detect the reaction product in the DNA chip 120.

The reaction plate 2c also has a cleaning solution container 17 formed in the top surface thereof. The cleaning solution container 17 contains a cleaning solution for separating the reaction product not having been bound to the probes immobilized to the DNA chip 120 from the reaction product having been bound to the probes and removing the former from the DNA chip 120. Further, the cleaning solution container 17 is sealed with a film through which the tip of the dispensation tip 20 can pass. The reagent container 12 previously contains a PCR reaction reagent. The reaction portion 4 serves as a PCR reaction container.

In a case where a gene sample is measured by the reaction container kit of the embodiment, the sample is introduced into the sample container 32, and then the reaction container is attached to the reaction container kit treatment equipment. In the reaction container kit treatment equipment, the sample contained in the sample container 32 is dispensed into the reaction portion 4 by the dispensation tip 20, and then a PCR reaction reagent contained in the reagent container 12 is also dispensed into the reaction portion 4 by the dispensation tip 20. Further, mineral oil (not shown) is layered onto a mixture of the sample and the reagent contained in the reaction portion 4, and then PCR reaction is performed by controlling the temperature of the mixture contained in the reaction portion 4 according to a predetermined temperature cycle.

After the completion of the PCR reaction, an obtained reaction mixture is supplied as a sample from the reaction portion 4 to the DNA chip 120 by the dispensation tip 20. Then, a cleaning solution is supplied from the cleaning solution container 17 to the DNA chip 120 by the dispensation tip 20, and then a reaction product not having been bound to the probes is removed by sucking the cleaning solution into the dispensation tip 20.

In order to detect the reaction product having been bound to the probes in the dispensation tip 20, the reaction container kit treatment equipment includes a detector 122. After the reaction product not having been bound to the probes is removed, the current value of each probe is measured by the detector 122.

It is to be noted that a gene sample can be measured even when the DNA chip 110 or 120 of the embodiment shown in FIG. 12 or 14 is replaced with a hybridization region.

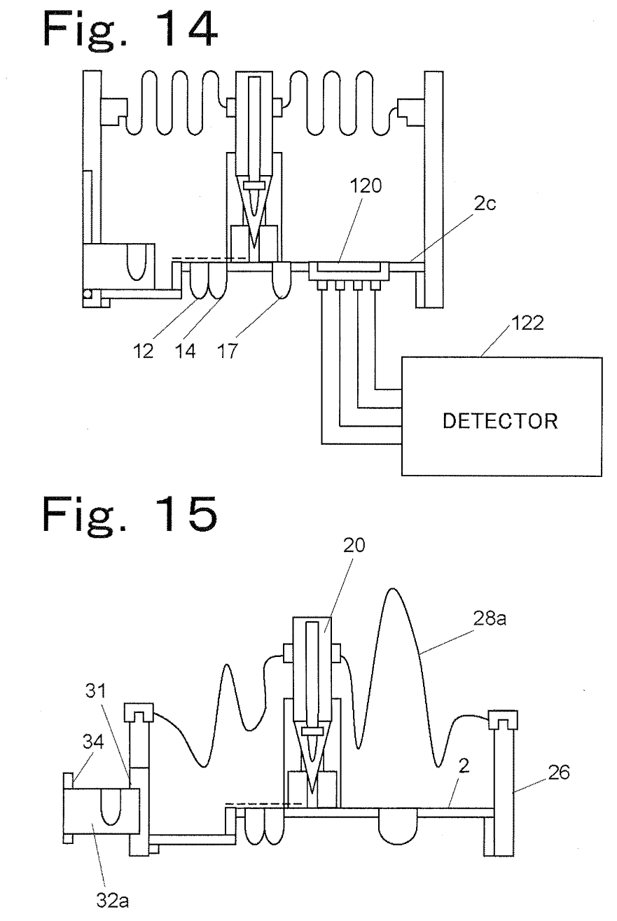

FIG. 15 shows another embodiment different in the structure of the cover. More specifically, the embodiment shown in FIG. 1 has a bellows film 28 as part of the cover movably supporting the dispensation tip 20 and covering a space above the reaction plate 2, but the embodiment shown in FIG. 15 has a flexibly deformable film 28a as part of the cover. As in the case of the bellows film 28, the film 28a is preferably made of Nylon®, polyvinyl chloride, or a rubber material such as silicone rubber.

In the embodiment shown in FIG. 1, one side of the sample container is supported by the cover main body 26 so that the sample container can rotate. On the other hand, the sample container 32a of the embodiment shown in FIG. 15 is different from the sample container shown in FIG. 1 in that it is slidably attached to the cover main body 26. Also in the case of using the sample container 32a, a sample can be dispensed into the sample container 32a by pulling the sample container 32a out of the cover main body 26. Further, the embodiment shown in FIG. 15 also has a bar code label 134 (see FIG. 1) to be stuck to the cover to hermetically seal the opening 31 after a sample is introduced into the space covered with the cover by the sample container 32a. A method for hermetically sealing the opening 31 with the bar code label 134 to be used in this case is the same as that used in the case of the embodiment shown in FIG. 1.

The detection unit 38a, 38b, or 38c is arranged in the reaction container kit treatment equipment so as to be located under the reaction plate 2 of the reaction container kit attached to the treatment equipment.

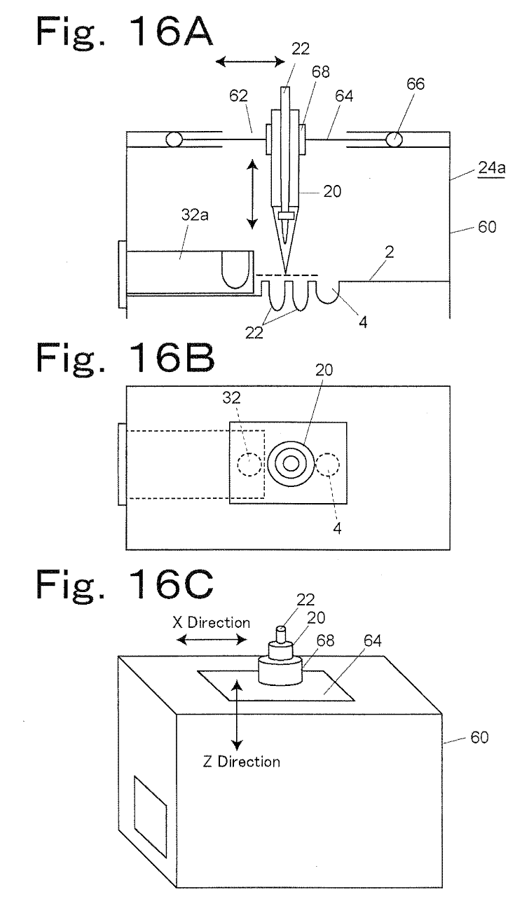

FIG. 16A shows a vertical sectional view of another embodiment of the reaction container kit, FIG. 16B is a horizontal sectional view of the reaction container kit shown in FIG. 16A, and FIG. 16C is a perspective view showing the appearance of the reaction container kit shown in FIG. 16A.

The embodiment shown in FIG. 16 has a cover movably supporting the dispensation tip 20, and the cover is made of a material having stiffness. A cover main body 60 of a cover 24a has an opening 62 located above the reaction plate 2. In the opening 62, a cover plate 64 for movably supporting the dispensation tip 20 is provided so that the dispensation tip 20 can be moved within a range defined by the opening 62. A part of the cover main body 60 around the opening 62 has a double structure having an interior gap, and a sealant 66 is provided around the periphery of the cover plate 64. The sealant 66 is moved in the X direction in the interior gap of the double structure provided around the opening 62 of the cover main body 60, which allows the cover plate 64 to move in the X direction in a horizontal plane. Further, the dispensation tip 20 is supported by the cover plate 64 by means of another sealant 68, which is interposed between the dispensation tip 20 and the cover plate 64, so as to be able to slide in the vertical direction (Z direction).

In the embodiment shown in FIG. 16, the cover plate 64 is moved in a horizontal plane while the reaction container kit is kept hermetically sealed by a sealing structure constituted from the cover plate 64, the sealant 66, and the interior gap of the double structure provided in the upper part of the cover main body 60, and the dispensation tip 20 is moved in the vertical direction while the reaction container kit is kept hermetically sealed by the sealant 68. This makes it possible to freely move the dispensation tip 20 in a space above the reaction plate 2 in two directions, i.e., in the vertical direction and a direction in a horizontal plane.

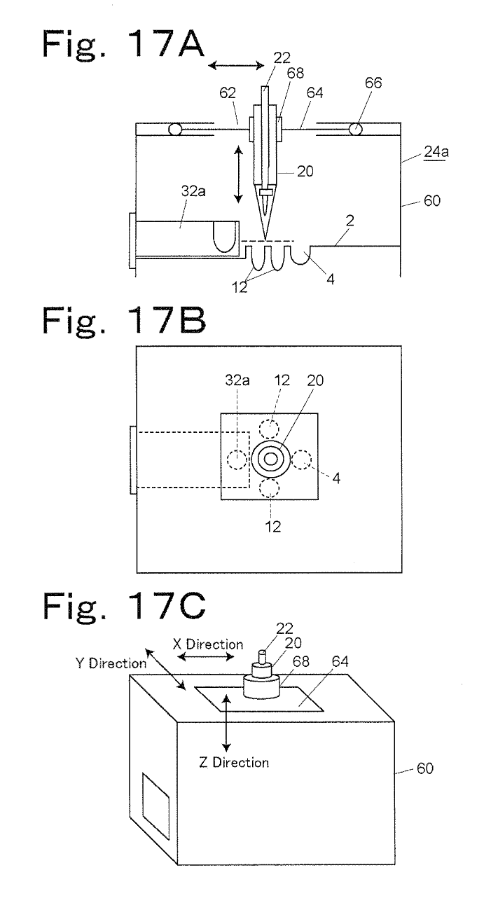

FIG. 17 shows another embodiment. The embodiment shown in FIG. 17 is the same as the embodiment shown in FIG. 16 except that the cover plate 64 can be moved in two directions, i.e., X and Y directions, and that the number of the reagent containers 12 provided in the reaction plate 2 is increased.

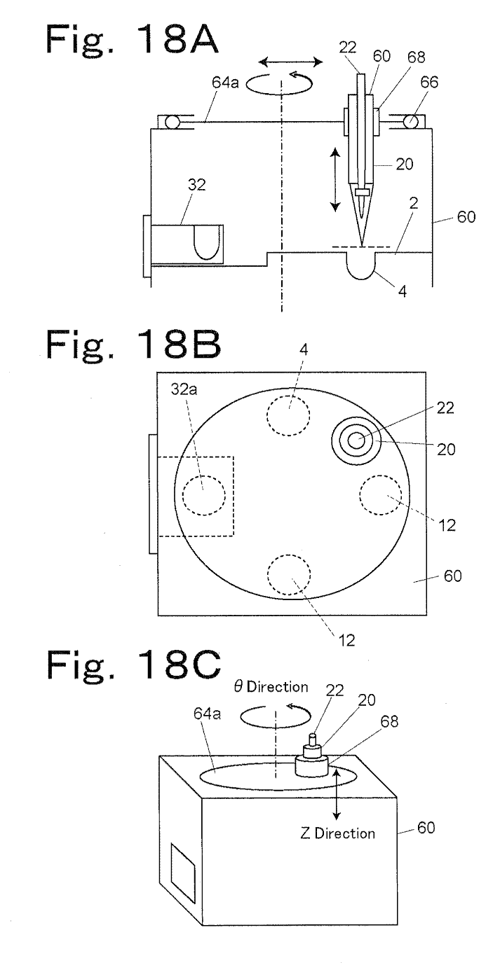

FIG. 18 shows another embodiment. The embodiment shown in FIG. 18 is different from the embodiment shown in FIG. 16 in that a cover plate 64a as an upper member of the cover is supported so as to be able to rotate in the in-plane direction to move the dispensation tip 20 in the in-plane direction. The cover plate 64a has a disc shape, and the sealant 66 is attached to the periphery of the cover plate 64a. The sealant 66 is held in the interior gap of the double structure provided in the upper part of the cover main body 60, and rotatably supports the cover plate 64a while keeping the reaction container kit hermetically sealed. The dispensation tip 20 is supported by the cover plate 64a by means of the sealant 68 so as to be able to move in the vertical direction. The dispensation tip 20 supported by the cover plate 64a is located off the center of rotation of the cover plate 64a.

By rotating the cover plate 64a, it is possible to move the dispensation tip 20 on the circumference of a circle whose center is the rotational center of the cover plate 64a. Therefore, the reaction portion 4 and the reagent containers 12 provided in the reaction plate 2 and the sample container 32 are arranged so as to be located on the movement locus of the dispensation tip 20.

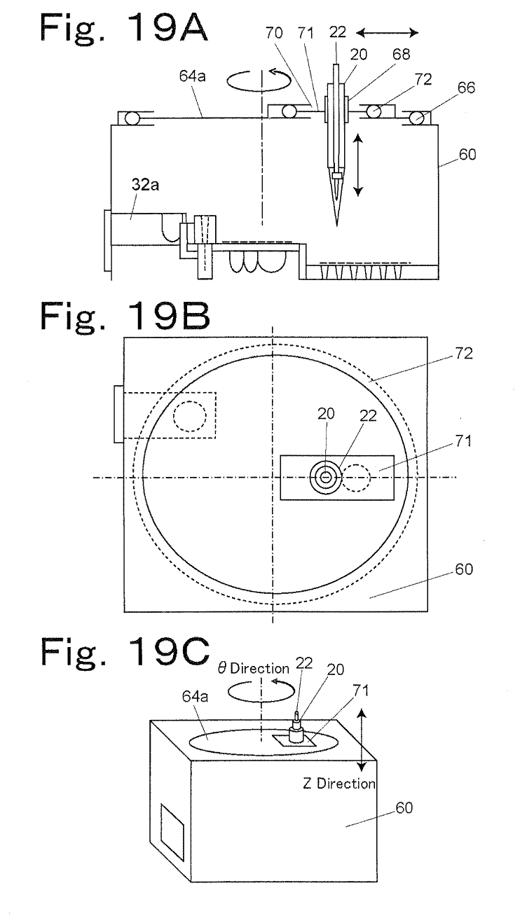

FIG. 19 shows another embodiment. The embodiment shown in FIG. 19 is different from the embodiment shown in FIG. 18 in that the cover plate 64a also has an opening 70, a double structure having an interior gap is provided around the opening 70, and another cover plate 71 is movably supported by the double structure by means of a sealant 72 held in the interior gap of the double structure. The dispensation tip 20 is supported by the cover plate 71 by means of another sealant 68 so as to be able to move in the vertical direction.

The dispensation tip 20 can be moved also in the in-plane direction by the sealant 72. Therefore, the dispensation tip 20 can be moved within a range defined by both the circumference of a circle obtained by rotating the cover plate 64a and a horizontal plane obtained by moving the smaller cover plate 71 movable by the sealant 72, that is, within a doughnut-shaped range whose center is the rotational center of the cover plate 64a. In the case of the embodiment shown in FIG. 19, the moving range of the dispensation tip 20 becomes larger, and therefore it is possible to increase the number of the reaction containers 4 and the reagent containers 12 arranged in the moving range of the dispensation tip 20. In addition, it is also possible to increase the degree of freedom of arrangement of these containers and the sample container 32.

FIG. 20 is a perspective view schematically showing the interior structure of one example of the reaction container kit treatment equipment for treating the reaction container kit according to the present invention.

The reference numeral 80 denotes the reaction container kit of the embodiment described above. The reaction container 80 is attached onto a table 82 provided as a reaction container attachment section. The table 82 has an opening on its surface facing the lower surface of the reaction container 80. Under the table 82, a detection unit 38 is arranged to optically detect a reaction product contained in the reaction portion 4 of the reaction container 82. On the table 82, a temperature control unit 83 is arranged to control the temperature of the reaction container 82. In a case where gene amplification reaction is carried out in the reaction portion 4 or a reaction container for gene amplification provided separately from the reaction portion 4 of the reaction container, the temperature control unit 83 is used to carry out temperature control for gene amplification reaction. Further, in a case where the reaction container has an analysis section requiring temperature control, the temperature control unit 83 is used to carry out temperature control of the analysis section. The temperature control unit 83 may have both the function of carrying out temperature control for gene amplification reaction and the function of carrying out temperature control of the analysis section. The detection unit 38 shown in FIG. 20 generically denotes the detection means shown in FIGS. 7 to 9. The table 82 is moved in a forward-backward direction (X direction), and on the other hand, the detection unit 38 is supported so as to be able to move in a lateral direction (Y direction) orthogonal to the moving direction of the table 82.

The drive unit 36 for driving the dispensation tip 20 is attached near the table 82 so as to be able to move in the Y and Z directions. As shown in FIG. 3, the drive unit 36 has a tip holding section 36a for holding the dispensation tip 20 by engaging with the proximal end of the dispensation tip 20 and a syringe drive section 36b for driving the syringe 22 by engaging with a plunger of the syringe 22 provided in the dispensation tip 20. The tip holding section 36a and the syringe drive section 36b are coaxially provided in the drive unit 36. Such a drive unit 36 allows both the movement of the dispensation tip 20 and the driving of the syringe 22 to be carried out.

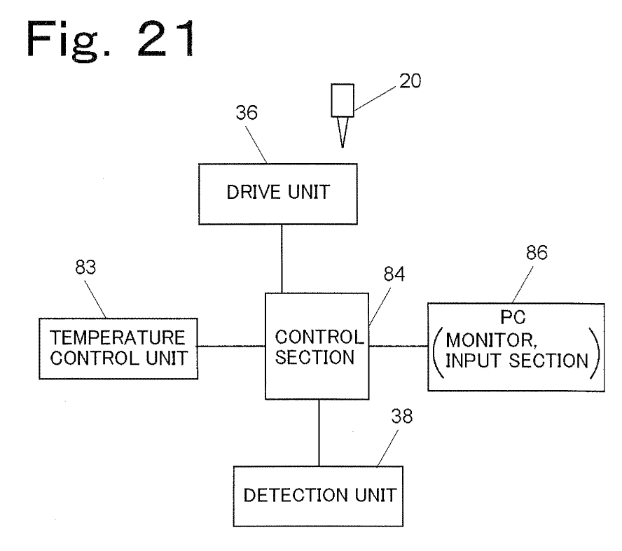

FIG. 21 is a block diagram showing the control system of one example of the reaction container kit treatment equipment. The reaction container kit treatment equipment includes a control section 84 for controlling the treatment of the reaction container 80 attached to the table 82. The control section 84 is constituted from a dedicated purpose computer (CPU) or a general-purpose personal computer. The control section 84 controls the movement of the dispensation tip 20 driven by the drive unit 36 engaged with the proximal end of the dispensation tip 20, dispensation operation by the dispensation tip 20, temperature control carried out by the temperature control unit 83, and the operation of the detection unit 38 for optically detecting a reaction product by irradiating the reaction portion 4 of the reaction container 80 with measuring light or excitation light.

In some drawings of the embodiments according to the present invention, the bar code label 134 is not shown, but what all the embodiments have in common is that a sealing member to be stuck to the cover main body so as to cover the outside of the sample container is provided outside the cover main body in order to hermetically seal the opening, through which the sample container is inserted into the space covered with the cover, after a sample is introduced into the space by the sample container.

In order to use the control section 84 as an input section externally operated or a monitor for displaying detection results, an external computer such as a personal computer (PC) 86 may be connected to the control section 84.

### INDUSTRIAL APPLICABILITY

The present invention can be applied to measurements of various reactions such as chemical reactions and biochemical reactions.

1. A reaction container kit comprising:
a reaction container having a reaction portion for carrying out a reaction of a sample and a reagent container containing a reagent for use in the reaction of the sample;
a first bar code label previously stuck to the reaction container and containing data to be read before sample dispensation into the reaction container, the first bar code label containing at least data indicating information unique to the reaction container; and
a second bar code label provided so as to be able to be stuck to the reaction container and containing data to be read after sample dispensation into the reaction container, the data being different from the data contained in the first bar code label.

2. The reaction container kit according to claim 1, wherein at least a part of the first bar code label is removed after data reading.

3. The reaction container kit according to claim 2, wherein
the reaction container has an opening constituting a sample introduction unit, and
the first bar code label is previously stuck to the sample introduction unit so that the opening can be opened only after removing a part of the first bar code label that should be removed.

4. The reaction container kit according to claim 3, wherein the second bar code label also serves as a sealing member for hermetically sealing the opening after sample injection.

5. The reaction container kit according to claim 3,
wherein the reaction container comprises:
a reaction plate having, on the top surface side thereof, the reaction portion and the reagent container;
a dispensation tip provided above the top surface of the reaction plate; and
a cover for covering the space above the top surface of the reaction plate and movably supporting the dispensation tip so that a distal end portion of the dispensation tip is inside the space and a proximal end portion of the dispensation tip is outside the space, and
wherein the opening is provided on the cover and the sample introduction unit is designed so that a sample can be introduced into the space from outside through the opening.

6. The reaction container kit according to claim 5, wherein the reagent container provided on the top surface side of the reaction plate is sealed with a film.

7. The reaction container kit according to claim 6, wherein the dispensation tip has a syringe to be operated from the outside of the cover and dispensation is carried out by operating the syringe.

8. The reaction container kit according to claim 6, wherein the dispensation tip has a filter inside the tip portion thereof.

9. The reaction container kit according to claim 5, wherein the reaction plate has, on the top surface side thereof, a gene amplification portion for carrying out gene amplification reaction.

10. The reaction container kit according to claim 5, wherein the reaction container is made of an optically-transparent material so that an optical measurement can be carried out from the bottom side thereof.

11. The reaction container kit according to claim 5, wherein the reaction plate further has, on the top surface side thereof, an analysis section for analyzing a reaction product produced in the reaction container.

12. The reaction container kit according to claim 11, wherein the analysis section is an electrophoresis portion for carrying out the electrophoretic separation of a reaction product.

13. The reaction container kit according to claim 11, wherein when the reaction product contains a gene, the analysis section is a region where probes which react with the gene are arranged.

14. The reaction container kit according to claim 5,
wherein the cover includes a cover main body having stiffness and integrated with the reaction plate, and an upper cover attached to the cover main body so as to be arranged above the top surface of the reaction plate, the upper cover being made of an airtight and flexible material for holding and movably supporting the dispensation tip, and
wherein the opening constituting the sample introduction unit is provided on the cover main body and the sealing member is to be stuck to the cover main body.

15. The reaction container kit according to claim 5,
wherein the cover includes a cover main body integrated with the reaction plate and a cover plate arranged above the top surface of the reaction plate, the cover plate being held by the cover main body by means of a sealing material so as to be able to slide in a horizontal plane while the air tightness of the reaction container is kept,
wherein the dispensation tip is held by the cover plate by means of another sealing material so as to be able to slide in a vertical direction while the air tightness of the reaction container is kept, and
wherein the opening constituting the sample introduction unit is provided on the cover main body, and a sealing member for hermetically sealing the opening is to be stuck to the cover main body.
